(19) United States
(12) Patent Application Publication
(10) Pub. No.: US 2015/0298904 A1
(43) Pub. Date: Oct. 22, 2015

(54) BIN LID CLOSING DEVICE

(71) Applicant: SHERRARD PTY LTD, City Beach (AU)

(72) Inventors: Philip Harry SHERRARD, City Beach (AU); Janelle Faye SHERRARD, City Beach (AU)

(73) Assignee: SHERRARD PTY LTD, City Beach (AU)

(21) Appl. No.: 14/648,529

(22) PCT Filed: Nov. 29, 2013
(86) PCT No.: PCT/AU2013/001391

§ 371 Date: May 29, 2015

(30) Foreign Application Priority Data
Dec. 3, 2012 (AU) 2012905243

(51) Int. Cl. B65F 1/14; E05F 1/10

(52) U.S. Cl. CPC B65F 1/1623; B65F 1/1473; E05F 1/1083

(57) ABSTRACT

A bin lid closing device 10 for use on bin 12 with a hinged lid 16 and a handle 18, has a bin handle engaging portion 20, a bin side engaging portion 22 and a bin lid engaging portion 24. The handle engaging portion 20 can be cylindrical 21 with a generally ‘C’ shaped opening 26 along its length. The side engaging portion 22 can be a first planar elongate member 23 connected to the cylindrical member 21. The lid engaging portion 24 can be a second planar elongate member 25 connected to the cylindrical member 21. The device can be moulded as a one piece plastic device or formed as one piece from bent spring steel. One or more adjusters, such as sleeves of different thicknesses, can be selected as packing members 36 to fit between the bin handle and the handle engaging portion to allow for any difference in width between the two.

### FIELD OF THE INVENTION

The present invention relates to a device for use on bins to return the lid to a closed position.

### BACKGROUND TO THE INVENTION

Bins for household rubbish, commonly referred to as ‘wheelie bins’ are generally collected by trucks with an automated mechanism for lifting and emptying. The mechanism comprises an arm which lifts the bin above the truck such that the lid falls open and the rubbish falls into the truck. Often when the emptied bin is returned to the ground, the lid will remain in the open position. This may be considered undesirable for a number of reasons. For example, in rainy weather the bin will fill with water. Also, it may be preferable to have the lid closed to retain unwanted odours within the bin.

The present invention relates to a device for use on this type of bin which is aimed at addressing the abovementioned issue by closing the lid after emptying. The device also generally keeps the lid in a closed position when full or partially filled, which prevents the rubbish being accessed by birds or vermin or being blown by the wind.

### SUMMARY OF THE INVENTION

According to one aspect of the present invention there is provided a bin lid closing device comprising:
a handle engaging portion for receiving a handle of a bin;
a side engaging portion extending outwardly from the handle engaging portion; and
a resilient lid engaging portion extending outwardly from the handle engaging portion;
wherein the side engaging portion engages a side of the bin to prevent rotation of the handle engaging portion relative to the handle and the lid engaging portion is engaged and flexed by the lid of the bin during opening such that a force is applied to the lid by the lid engaging portion to close the lid.

Preferably the handle engaging portion includes a recess to receive the handle of the bin.

The handle engaging portion may be shaped so as to receive a cylindrical handle of the bin.

Preferably, the handle engaging portion comprises a cylindrical member having an opening along the length thereof.

Preferably the side engaging portion, the lid engaging portion and the handle engaging portion are formed or moulded as a one piece device, such as by injection moulding plastic or bending of spring steel. Alternatively, one or both of the side engaging portion and lid engaging portion can be attached to (and preferably detachable from) the handle engaging portion.

Resilience in the lid engaging portion may be assisted by one or more biasing members, such as a spring.

Preferably the side engaging portion comprises a first elongate member connected to the cylindrical member adjacent a first side of the opening.

Preferably the lid engaging portion comprises a second elongate member connected to the cylindrical member adjacent a second side of the opening.

Preferably the first and/or second elongate member(s) is/are planar, having a width significantly greater than their respective thickness.

In a preferred embodiment, the widths of the first and second planar elongate members are the same as that of the cylindrical member.

In one embodiment, the connection between the first planar elongate member and the cylindrical member is such that the first planar elongate member is generally parallel to the portion of the cylindrical member adjacent the first side of the opening and the connection between the second planar elongate member and the cylindrical member is such that the second planar elongate member is generally parallel to the portion of the cylindrical member adjacent the second side of the opening.

Preferably, the first planar elongate member includes an end flange portion at a distal end thereof wherein the end flange portion extends from the first planar elongate member at an acute angle thereto on a side located adjacent the second planar elongate member.

### BRIEF DESCRIPTION OF THE DRAWINGS

The invention will now be described, by way of example, with reference to the following drawings in which:

FIG. 1 is an upper perspective view of a bin lid closing device in accordance with an embodiment of the present invention;

FIG. 2a is a side view of the bin lid closing device of FIG. 1;

FIG. 2b is a front view of the bin lid closing device of FIG. 1;

FIG. 2c is a top view of the bin lid closing device of FIG. 1;

FIG. 2d is a rear view of the bin lid closing device of FIG. 1;

FIG. 3 is a side view of the bin lid closing device of FIG. 1 showing flexing of the lid engaging portion;

FIG. 4a is a side view of the bin lid closing device according to an embodiment of the present invention shown engaged with a bin with the lid in a closed position;

FIG. 4b is a side view of the bin lid closing device according to an embodiment of the present invention engaged with the bin with the lid in a partially open position;

FIG. 4c is a side view of the bin lid closing device according to an embodiment of the present invention engaged with the bin with the lid in an open position;

FIG. 5 is an upper perspective view of the bin lid closing device according to an embodiment of the present invention engaged with the bin with the lid in a closed position;

FIG. 6 is an upper perspective view of the bin lid closing device according to an embodiment of the present invention engaged with the bin with the lid in a first open position;

FIG. 7 is an upper perspective view of the bin lid closing device according to an embodiment of the present invention engaged with the bin with the lid in a second open position;

FIG. 8 is an upper perspective view of the bin lid closing device according to an embodiment of the present invention engaged with the bin with the lid in a third open position;

FIG. 9 is an upper perspective view of the bin lid closing device according to an embodiment of the present invention engaged with the bin with the lid in a fourth open position;

FIG. 10 is an upper perspective view of a second embodiment of a bin lid closing device in accordance with the present invention;

FIG. 11a is a side view of the bin lid closing device of FIG. 10;

FIG. 11b is a front view of the bin lid closing device of FIG. 10;

FIG. 11c is a top view of the bin lid closing device of FIG. 10;

FIG. 11d is a rear view of the bin lid closing device of FIG. 10;

FIG. 12 is an upper perspective view of a third embodiment of a bin lid closing device in accordance with the present invention;

FIG. 13a is a side view of the bin lid closing device of FIG. 12;

FIG. 13b is a front view of the bin lid closing device of FIG. 12;

FIG. 13c is a top view of the bin lid dosing device of FIG. 12;

FIG. 13d is a rear view of the bin lid closing device of FIG. 12;

FIG. 14 is an upper perspective view of a fourth embodiment of a bin lid closing device In accordance with the present invention;

FIG. 15a is a side view of the bin lid closing device of FIG. 14;

FIG. 15b is a front view of the bin lid closing device of FIG. 14;

FIG. 15c is a top view of the bin lid closing device of FIG. 14;

FIG. 15d is a rear view of the bin lid closing device of FIG. 14;

FIG. 15e is bottom view of the bin lid closing device of FIG. 14;

FIG. 16 is an upper perspective view of a packing member for use with the bin lid closing device according to an embodiment of the present invention;

FIG. 17 is an upper perspective view of the bin lid closing device of FIG. 14 secured to a handle of a bin using the packing member;

FIG. 18a is a side cross sectional view of the bin lid closing device of FIG. 14 secured to a handle of a bin using the packing member; and

FIG. 18b is a close up view of Detail A of FIG. 18a.

### DESCRIPTION OF PREFERRED EMBODIMENT

Referring to the Figures, there is shown a bin lid closing device 10 for use on a bin 12 of a known type.

The bin 12 comprises a body 14 formed generally from four side walls and a lid 16. A cylindrical handle 18 is provided adjacent an upper end of a rear side wall of the bin 12. The lid 16 is pivotally secured to the handle 18 in a known manner.

The bin lid closing device 10 comprises generally a handle engaging portion 20, a side engaging portion 22 and a lid engaging portion 24. The handle engaging portion 20 comprises a cylindrical member 21 having an opening 26 along the length thereof. That is, the handle engaging portion comprises generally a C-shaped tube.

The side engaging portion 22 comprises a first planar elongate member 23 connected to the cylindrical member 21. The first planar elongate member 23 is connected to the cylindrical member 21 adjacent a first side 28 of the opening 26. The width of the first planar elongate member 23 is the same as that of the cylindrical member 21. The connection between the first planar elongate member 23 and the cylindrical member 21 is such that the first planar elongate member 23 is generally parallel to the portion of the cylindrical member 21 adjacent the first side 28 of the opening 26.

The lid engaging portion 24 comprises a second planar elongate member 25 connected to the cylindrical member 21. The second planar elongate member 25 is connected to the cylindrical member 21 adjacent a second side 29 of the opening 26. The width of the second planar elongate member 25 is the same as that of the cylindrical member 21. The connection between the second planar elongate member 25 and the cylindrical member 21 is such that the second planar elongate member 25 is generally parallel to the portion of the cylindrical member 21 adjacent the second side 29 of the opening 26.

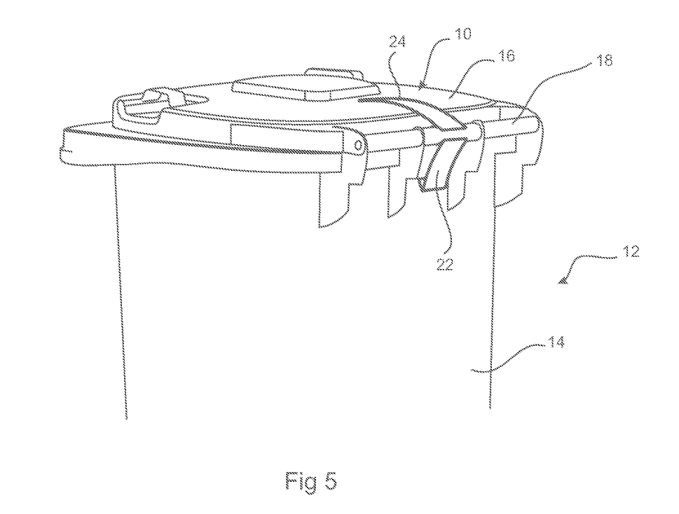

As can be seen in the Figures, the side engaging portion 22 and the lid engaging portion 24 extend away from the cylindrical member 21 in a direction generally away from the opening 26 such that the angle between the side engaging portion 22 and the lid engaging portion 24 is less than ninety degrees. Therefore, when the handle engaging portion 20 is engaged with the handle 18 of the bin 12 with the opening 26 facing generally away from the bin 12, the side engaging portion 22 extends downwardly towards the rear side wall of the bin 12 and the lid engaging portion 24 extends across the top of the rear of the lid 16, as can be seen in FIG. 5.

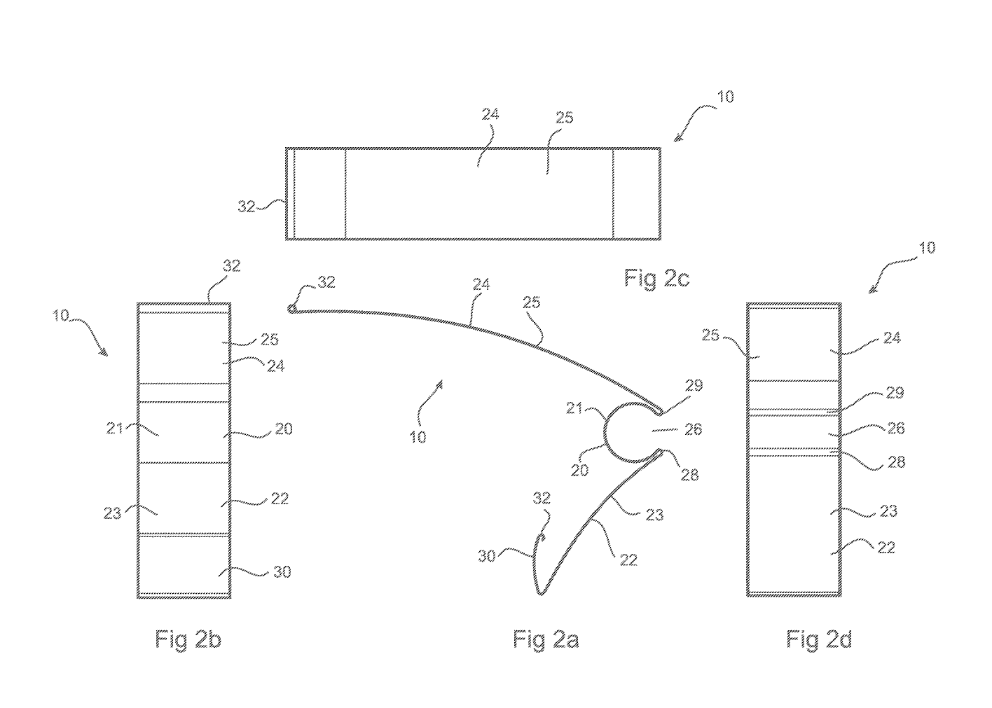

The second planar elongate member 25 is slightly arcuate in shape as can be seen in FIG. 2 such that it engages with the lid 16 generally only adjacent its distal end.

The first planar elongate member 23 includes an end flange portion 30 at a distal end thereof. The end flange portion 30 extends from the first planar elongate member 23 at an acute angle thereto on a side to be located adjacent the second planar elongate member 25.

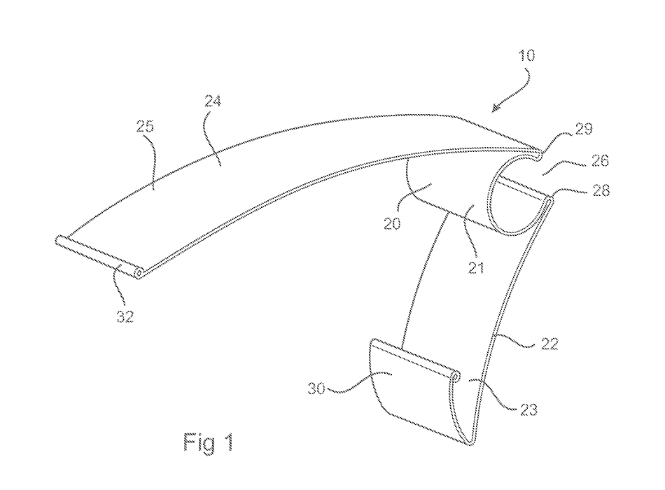

The embodiment shown in FIGS. 1 and 2 is suitable to be formed from metal. The lid engaging portion 24, the handle engaging portion 20, the side engaging portion 22 arid the end flange portion 30 are all to be formed from a single planar length of metal sheet bent into the shape shown. Distal ends of the lid and side engaging portions 24 arid 22 include rolled portions 32 to create smooth ends. The sheet metal comprises a resilient material. For example spring steel, such that the lid and side engaging portions 24 and 22 can resiliently flex relative to the handle engaging portion 20.

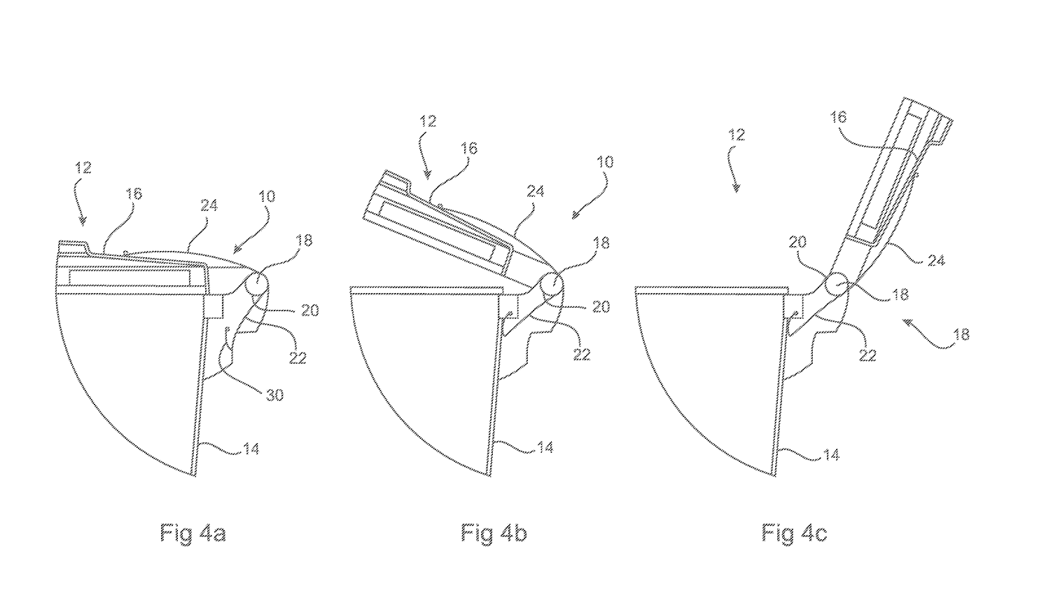

The bin lid closing device 10 is engaged with the bin 12 by flexing apart the lid and side engaging portions 24 and 22 and Inserting the side engaging portion 22 downwardly between the handle 18 and the rear side wall of the bin 12. The handle engaging portion 20 is then engaged with the handle 18 by receiving the handle 18 in the opening 26. The bin lid closing device 10 is then in place as shown in FIGS. 4a and 5, with the lid engaging portion 24 extending across the upper surface of the lid 16 and the side engaging portion 22 extending downwardly adjacent the rear side wall of the bin 12.

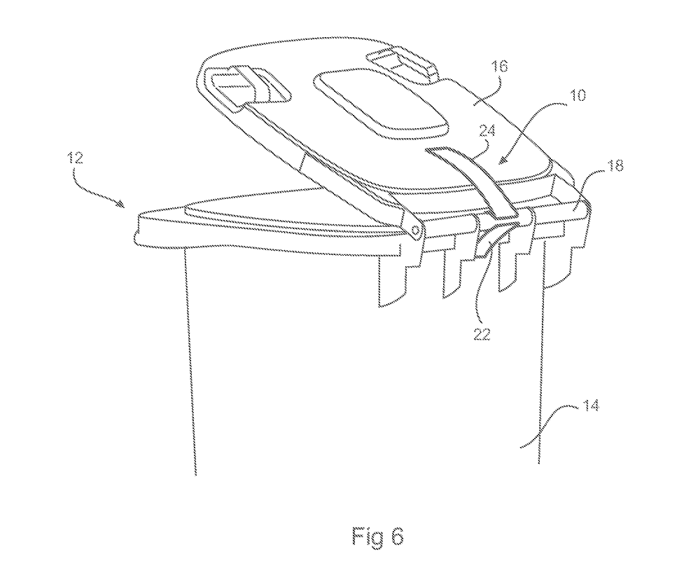

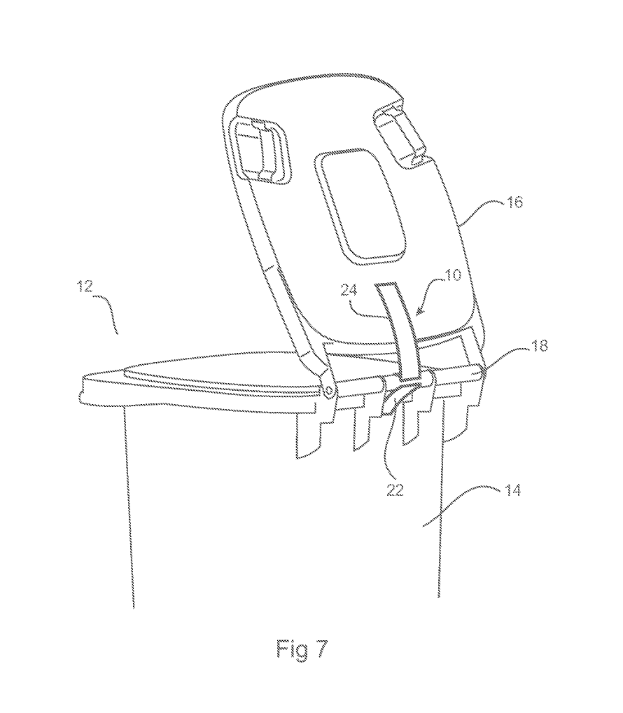

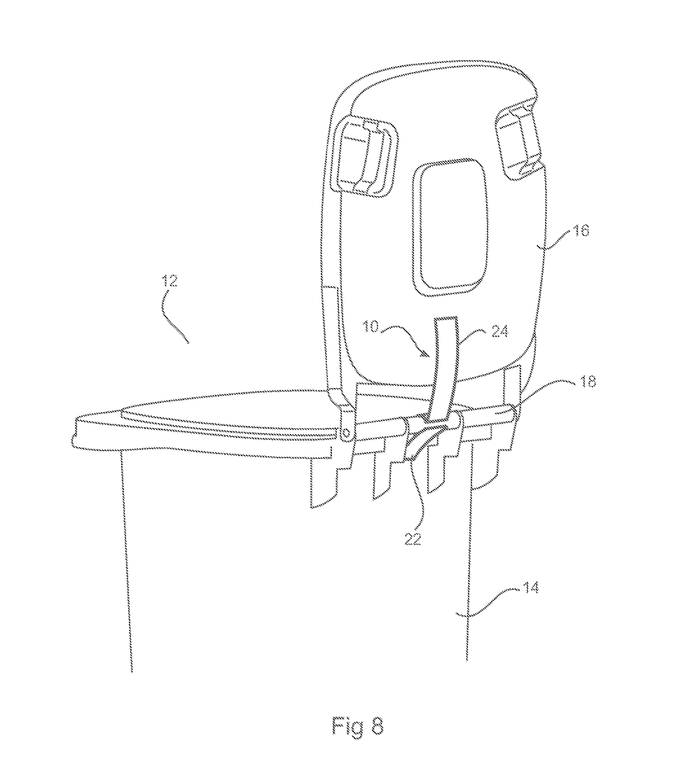

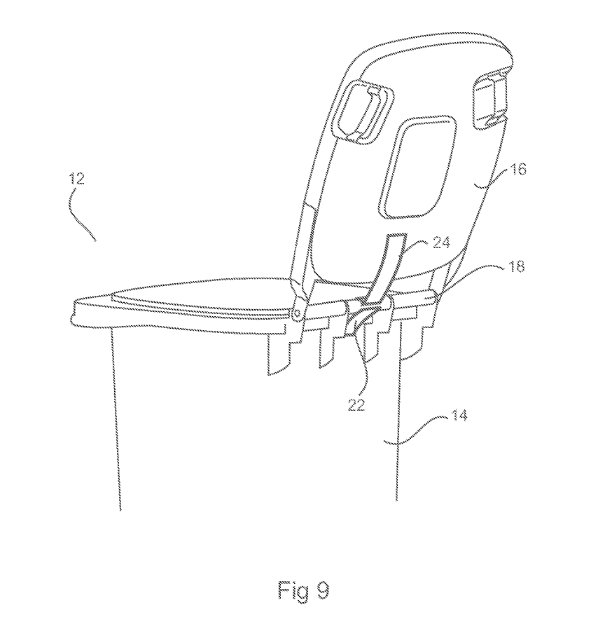

On lifting the lid 16 of the bin 12, the lid 16 engages with the lid engaging portion 24 and flexes it upwardly. As the side engaging portion 22 is in contact with the rear side wall of the bin 12, the lid engaging portion 24 flexes outwardly relative to the side engaging portion 22, as can be seen in FIGS. 4b and 4c and FIGS. 6 to 9. Due to the resilient nature of the bin lid closing device 10, when the lid 16 is released the lid engaging portion 24 tends to flex back and applies a force to close the bin 12.

During the process of emptying the bin 12, turning the bin 12 upside down will cause the rubbish within the bin 12 to fall onto the lid 16 and apply the force necessary to assist gravity opening the lid 16 of the upturned bin. Once emptied and while being returned to an upright position, the bin lid closing device 10 will apply force to return the lid 16 to the closed position.

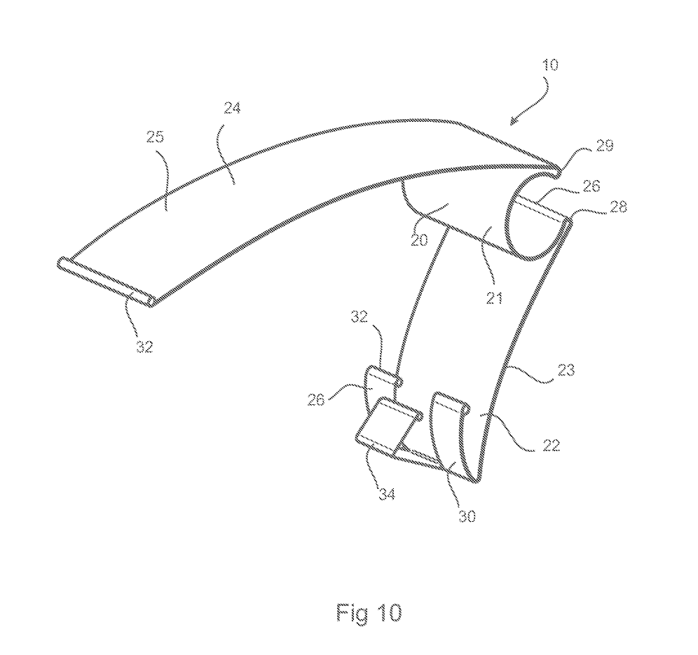

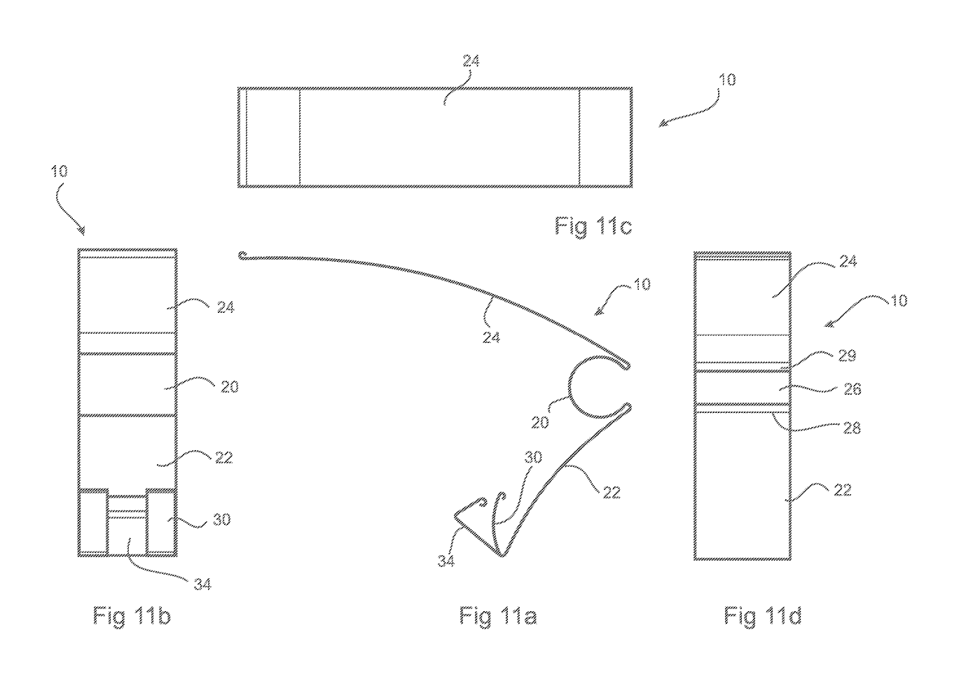

FIGS. 10 and 11 show a second embodiment of a bin lid closing device 10 in accordance with the present invention. The bin lid closing device 10 of FIGS. 10 and 11 is similar to the previously described embodiment other than the end flange portion 30. The end flange portion 30 includes a central portion 34 which extends out of the plane of the end flange portion 30. The central portion 34 comprises an L-shaped portion extending at an angle to the side engaging portion 22 being greater than that of the end flange portion 30. The central portion 34 is flexible relative to the side engaging portion 22 such that the central portion 34 engages the rear side wall of the bin 12 first to provide additional flex.

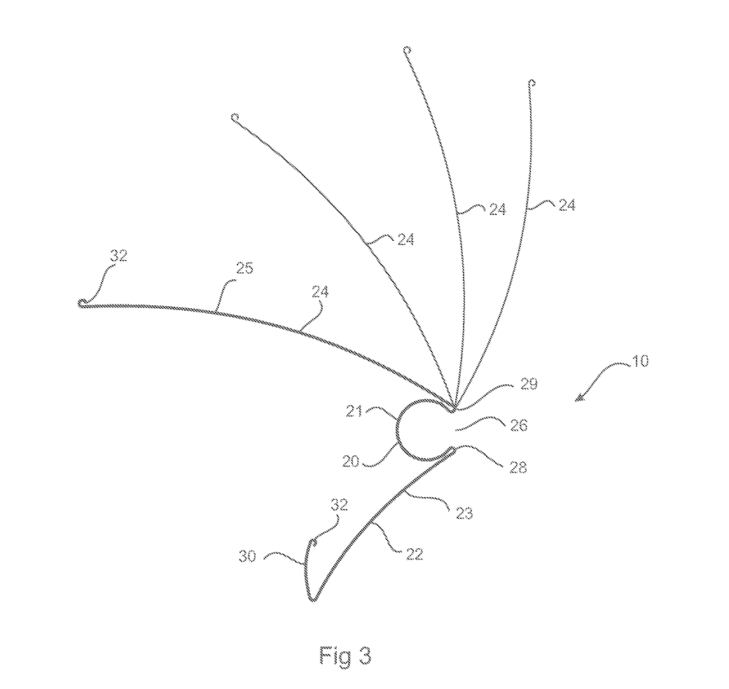

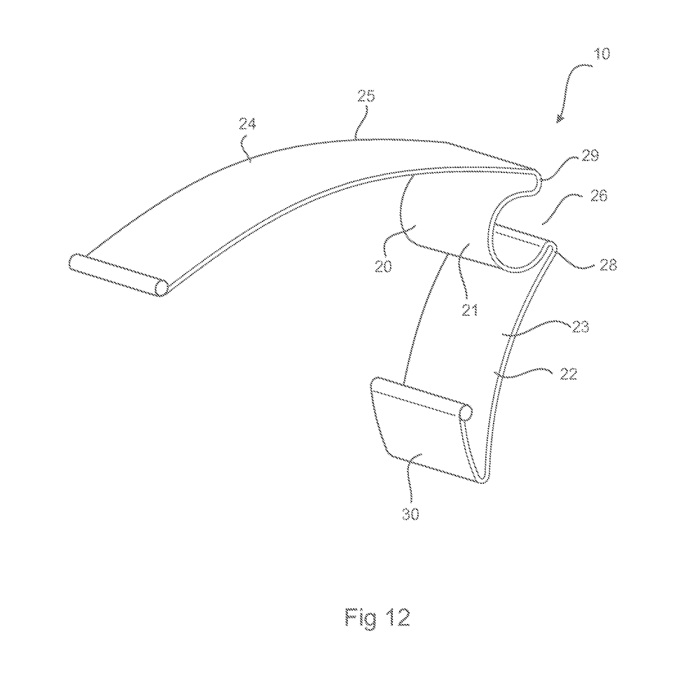

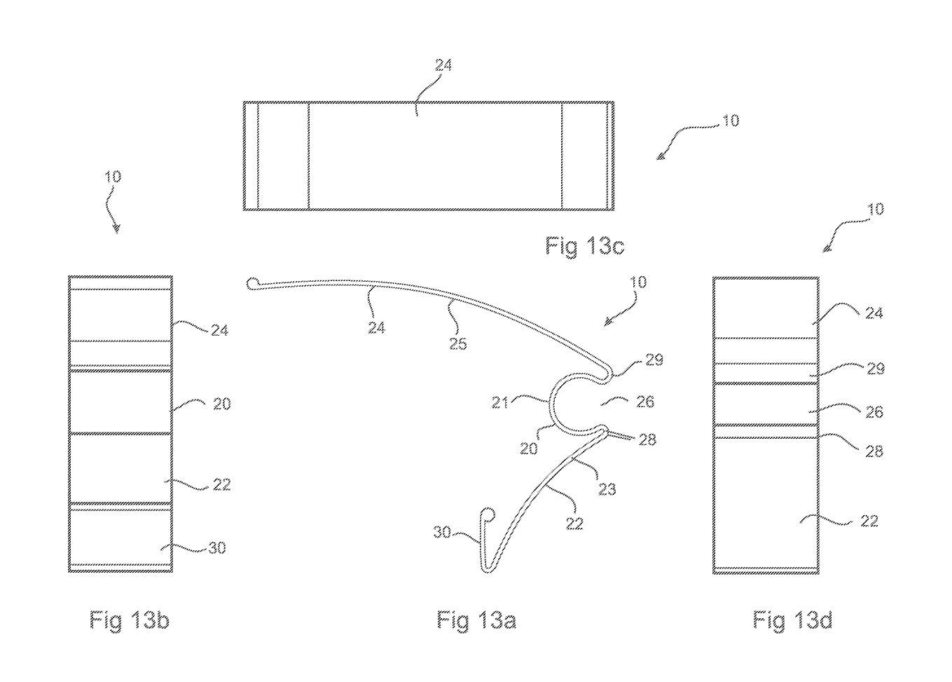

FIGS. 12 and 13 show a third embodiment of a bin lid closing device 10 in accordance with the present invention. The embodiment of FIGS. 12 and 13 is similar in shape to that of FIGS. 1 to 9 but is of a configuration suitable for formation from plastic, rather than a bent metal sheet.

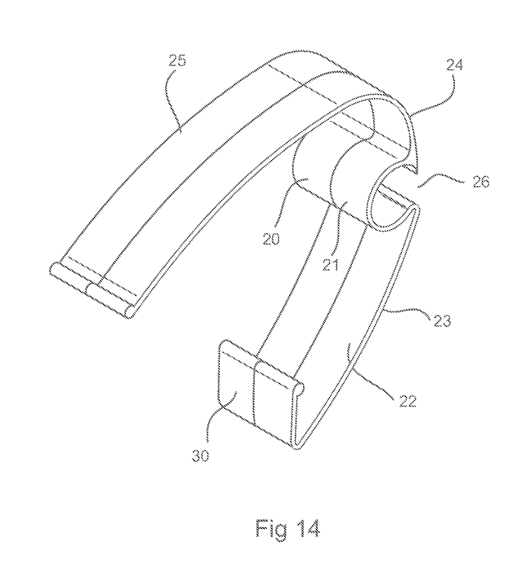

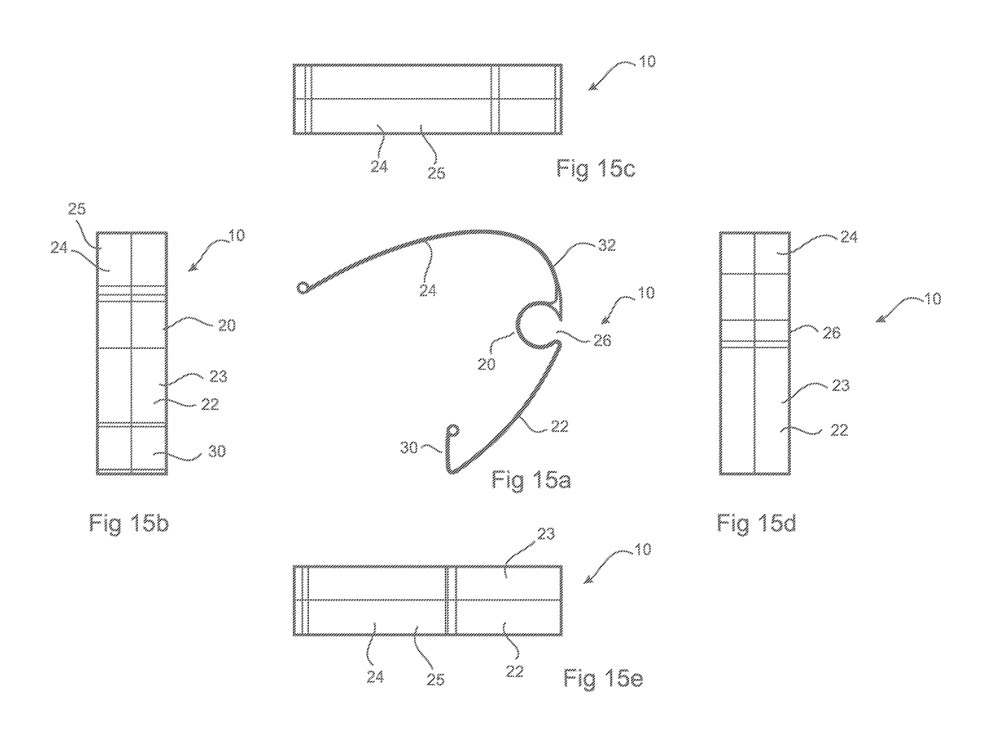

FIGS. 14 and 15 show a fourth embodiment of a bin lid closing device 10 in accordance with the present invention. The embodiment of FIGS. 14 and 15 is also expected to be formed of a plastic material and includes a modified shape for the lid engaging portion 24 and the side engaging portion 22.

The first and second planar elongate members 23 and 25 forming the side and lid engaging portions 22 and 24 extend away from the cylindrical member 21 in generally opposite directions. The second planar elongate member includes a greater curve than that of the previous embodiments.

As can be seen in FIG. 15a, the first and second elongate members 23 and 25 define generally a smooth curve. This increased curved shape is provided to distribute the bending force along a greater portion of the lengths of the first and second planar elongate members 23 and 25. This is expected to provide a smoother increase in the force applied to the lid 16 of the bin 12 during opening.

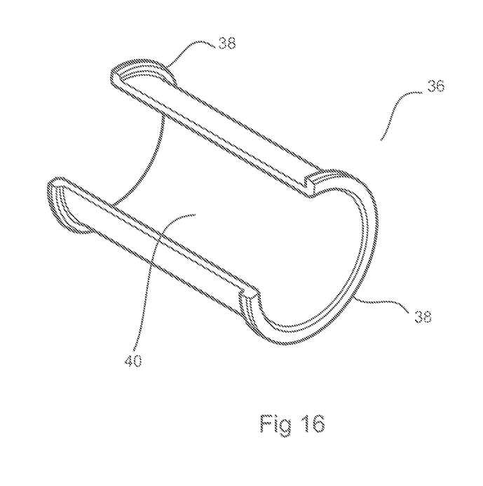

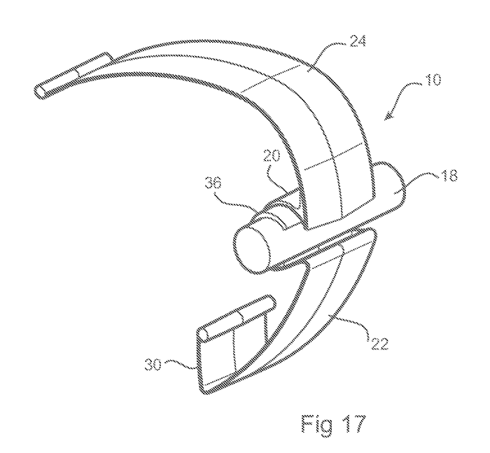

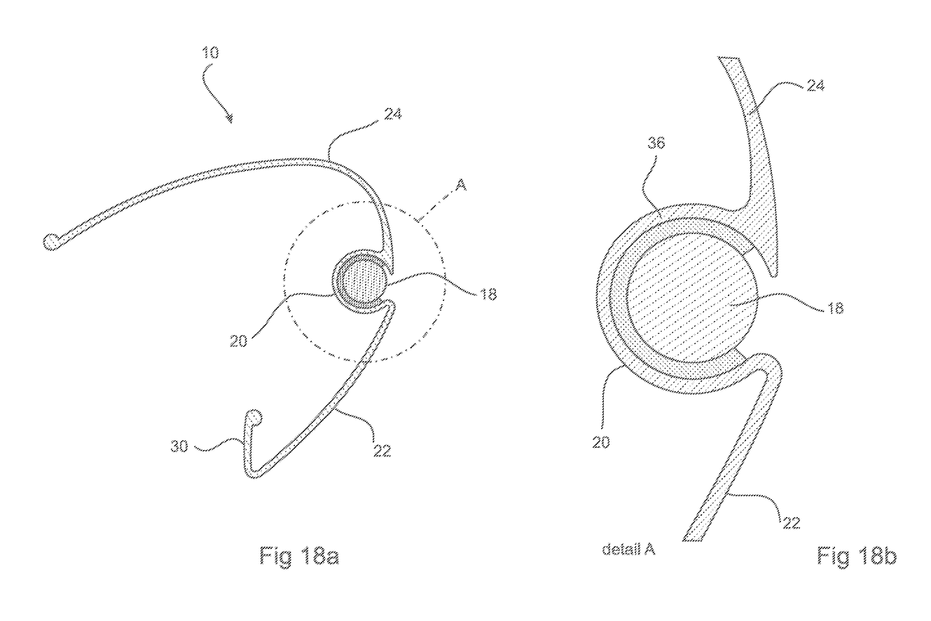

FIGS. 16 to 18 show a packing member 36 for use with the bin lid closing device 10 of the present invention. The packing member 36 comprises a cylinder having a slot 40 along the length thereof. The cylinder also includes circular flanges 38 at each end. The cylinder has an outer diameter equivalent to the inner diameter of the cylindrical member 21 of the handle engaging portion 20 of the bin lid closing device 10.

The packing member 36 may therefore be received in the handle engaging portion 20 between the handle engaging portion 20 and the handle 18 in the case where the handle 18 is of a smaller diameter. Multiple packing members 36 may be provided having different thicknesses to allow use of the bin lid closing device 10 on bins 12 with varying thickness handles 18.

It will be appreciated that the first and second elongate members can be of any suitable width to suit the bin on which the device is to be mounted.

Larger or heavier bin lids may require a wider (and therefore tougher and more resilient) first and/or second elongate member. It will be readily apparent to persons skilled n the relevant arts that various modifications and improvements may be made to the foregoing embodiments, in addition to those already described, without departing from the basic inventive concepts of the present invention.

1. A bin lid closing device comprising: a handle engaging portion having a recess for receiving a cylindrical handle of a bin; a side engaging portion extending outwardly from the handle engaging portion; and a resilient lid engaging portion extending outwardly from the handle engaging portion; wherein the side engaging portion engages a side of the bin to prevent rotation of the handle engaging portion relative to the handle and the lid engaging portion is engaged and flexed by the lid of the bin during opening such that a force is applied to the lid by the lid engaging portion to close the lid.

2. The bin lid closing device of claim 1, wherein the handle engaging portion includes a recess to receive the handle of the bin.

3. The bin lid closing device of claim 1, wherein the handle engaging portion is shaped so as to receive a cylindrical handle of the bin.

4. The bin lid closing device of claim 1, the handle engaging portion including a cylindrical member having an opening along the length thereof.

5. The bin lid closing device of claim 1, wherein the side engaging portion includes a first planar elongate member connected to the cylindrical member adjacent a first side of the opening.

6. The bin lid closing device of claim 1, wherein the lid engaging portion includes a second planar elongate member connected to the cylindrical member adjacent a second side of the opening.

7. The bin lid closing device of claim 1, wherein the first and second planar elongate members each has a width substantially the same as that of the cylindrical member.

8. The bin lid closing device of claim 1, wherein connection between the first planar elongate member and the cylindrical member is such that the first planar elongate member is generally parallel to the portion of the cylindrical member adjacent the first side of the opening.

9. The bin lid closing device of claim 8, wherein connection between the second planar elongate member and the cylindrical member is such that the second planar elongate member is generally parallel to the portion of the cylindrical member adjacent the second side of the opening.

10. The bin lid closing device of claim 1, wherein the first planar elongate member includes an end flange portion at a distal end thereof wherein the end flange portion extends from the first planar elongate member at an acute angle thereto on a side located adjacent the second planar elongate member.

11. The bin lid closing device of claim 2, the handle engaging portion including a cylindrical member having an opening along the length thereof.

12. The bin lid closing device of claim 3, the handle engaging portion including a cylindrical member having an opening along the length thereof.
